(19) United States
(12) Patent Application Publication
(10) Pub. No.: US 2004/0042370 A1
(43) Pub. Date: Mar. 4, 2004

(54) Recording method, reproducing apparatus, recording medium

(75) Inventors: Naozumi Sugimura, Yokohama (JP); Taku Hoshizawa, Kawasaki (JP); Osamu Kawamae, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/442,361

(22) Filed: May 20, 2003

(30) Foreign Application Priority Data
Aug. 28, 2002 (JP) 2002-247964

(51) Int. Cl. G11B 7/0045

(52) U.S. Cl. 369/59.25

(57) ABSTRACT

An object of the present invention is to provide a recording technique for efficiently using a record area of a recording medium. To achieve the object, in a method for recording data and management information which manages the data onto the recording medium, data 2 is recorded from a position (105) inward from data 1 already recorded on a data recording area having an undetermined data amount, and the management information 2 is recorded from a position (103b) outward from management information 1 already recorded on a management information recording area having an undetermined data amount.

### BACKGROUND OF THE INVENTION

The present invention relates to a technique for recording data onto a recording medium, more particularly, to a technique for recording data and management information which manages the data onto a recording medium.

When data is recorded as a file onto a recording medium, the data and management information which manages the data need to be recorded onto a recording medium.

For example, JP-A no.23312/2001 discloses a technique for separating clearly between a data recording area and a management information recording area, for previously determining an amount of the management information recording area, for recording the management information from the inside of a recording medium, and for recording the data from the outside of the recording medium.

### SUMMARY OF THE INVENTION

When such a technique was executed in a recording apparatus, problems described below were not taken into account.

First, when the management information area was previously determined on a non-rewritable recording medium, the recording area could not be efficiently used. This is because an amount of the management information area changes widely according to the number of files to be recorded and to a frequency of additional recording so that an optimum amount of the area cannot be determined. For example, if the management information area comes short before the data recording area is fully used, data cannot be recorded onto the data recording area still having a recordable space. On the other hand, if the data recording area is fully used, the management information cannot be recorded onto the management information area still having a recordable space, which is thus wasted.

Second, when a data recording area is provided on the outside of a recording medium, and when data is recorded outward from a position separated inward by an amount of the data, the amount needs to be previously determined. However, the amount cannot be always previously determined. For example, when a video recorder records image/sound data, an amount of the image/sound data changes widely according to a recording rate and recording time of the data. The prior technique could not be applicable to such a case.

An object of the present invention is to solve the problems of the prior technique. Another object of the present invention is to provide a recording technique for efficiently using a recording area on a recording medium.

To achieve the above-described objects, the present invention provides a technique for recording data and management information which manages the data onto a recording medium. In this method, the data is recorded from a position separated inward from other data already recorded on a data recording area where an amount of data to be recorded is not determined, and the management information is recorded from a position separated outward from other management information already recorded on a management information recording area where an amount of data to be recorded is not determined.

Additionally, in a method for recording data and management information which manages the data onto a recording medium, each predetermined recording unit of the data is recorded from a position separated inward from other data already recorded on a data recording area where an amount of data to be recorded is not determined, and the management information is recorded from a position separated outward from other management information already recorded on a management information recording area where an amount of data to be recorded is not determined.

Other and further objects, features and advantages of the invention will appear more fully from the following description.

### BRIEF DESCRIPTION OF THE DRAWINGS

FIG. 1 is an image diagram of data recording;

FIG. 2 is an image diagram of an optical disk;

FIG. 3 is a block diagram of a recording/reproducing apparatus; and

FIG. 4 is an image diagram of data recording.

### DETAILED DESCRIPTION OF THE PREFERRED EMBODIMENTS

A recording/reproducing apparatus of a first embodiment will be explained in detail in the following. In this embodiment, a recording medium is a non-rewritable optical disk, and data is additionally recorded.

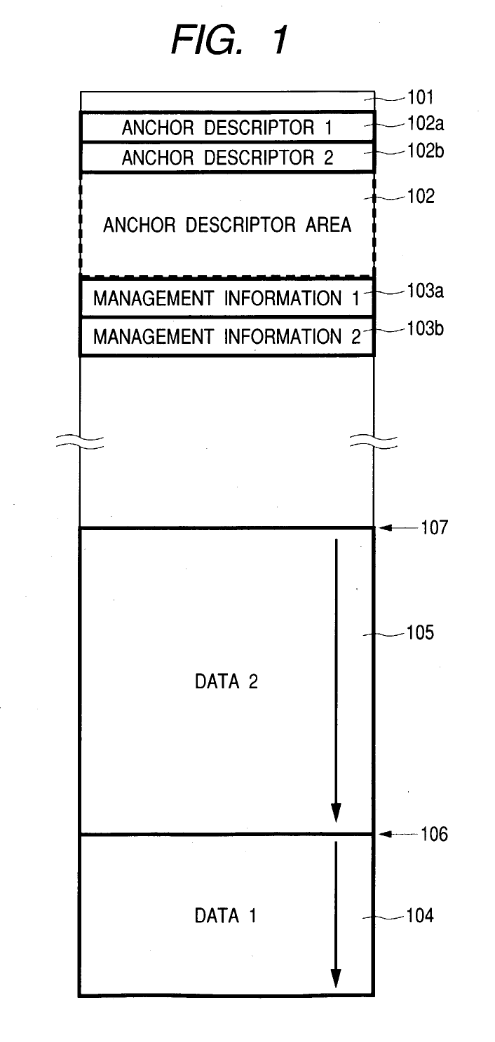

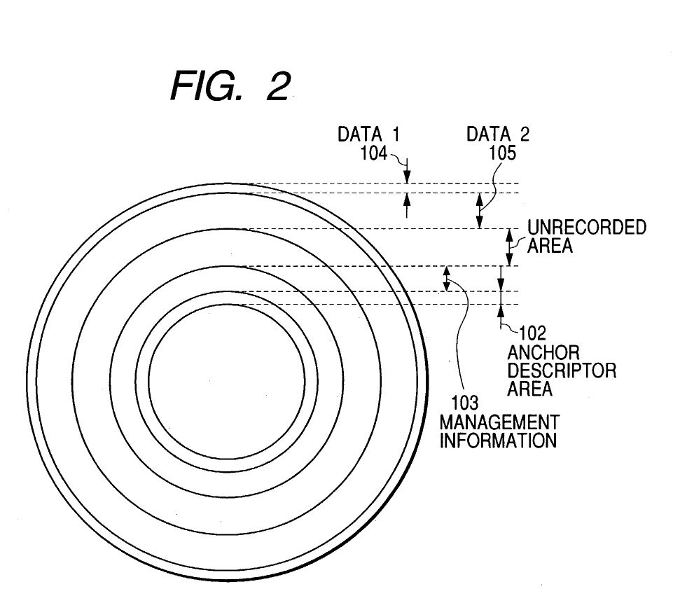

FIG. 1 shows file arrangement on an optical disk of this embodiment. FIG. 2 is an image diagram of recording areas on the optical disk. FIGS. 1, 2 use the common symbols.

A recording area 101 is comprised of sectors each having a predetermined data amount. Data of 2,048 bytes can be recorded onto each sector. The sectors are numbered sequentially, starting from the center of the disk. The sectors to be accessed can be specified using the sector numbers.

An anchor descriptor shows an area where management information is recorded. When a position of an area for file management is changed, an anchor descriptor is added to change a readout position of the management information area. When a plurality of anchor descriptors are recorded onto an anchor descriptor area, only the last anchor descriptor is recorded to decrease the frequency of the rewriting on the anchor descriptor area. The anchor descriptor includes not only a recorded position of the management information but also several pieces of information. The data amount of the anchor descriptor can be recorded sufficiently on one ECC block. One piece of additional recording of the anchor descriptor needs a data amount of 16 sectors equivalent to one ECC block.

In this embodiment, although data amounts of a data area and management information area are not previously determined, a data amount of an anchor descriptor area is previously determined. This is because if the anchor descriptor recording area is not previously determined, a starting position for recording the management information cannot be determined because the anchor descriptors are usually recorded from the inside of an optical disk. The number of anchor descriptors is proportional to the number of pieces of the management information. Thus, a data amount of the anchor descriptor area can be previously determined according to the frequency of the additional recording. For example, when the frequency of the additional recording is assumed to be 1,000 times, a data amount of the anchor descriptor area may be equivalent to 16,000 sectors. The anchor descriptors may not be recorded on the optical disk. In this case, the management information is recorded from the inside of the optical disk so that the recording area of the optical disk can be used more efficiently.

Management information 103 manages a recorded position, data amount, file identifier (file name), file generation time, or file type of data 104, 105 recorded on the optical disk.

The data 104, 105 are image or sound data recorded by a user.

Recording of data by a recording apparatus of this embodiment will be explained in the following with reference to FIGS. 1 to 3.

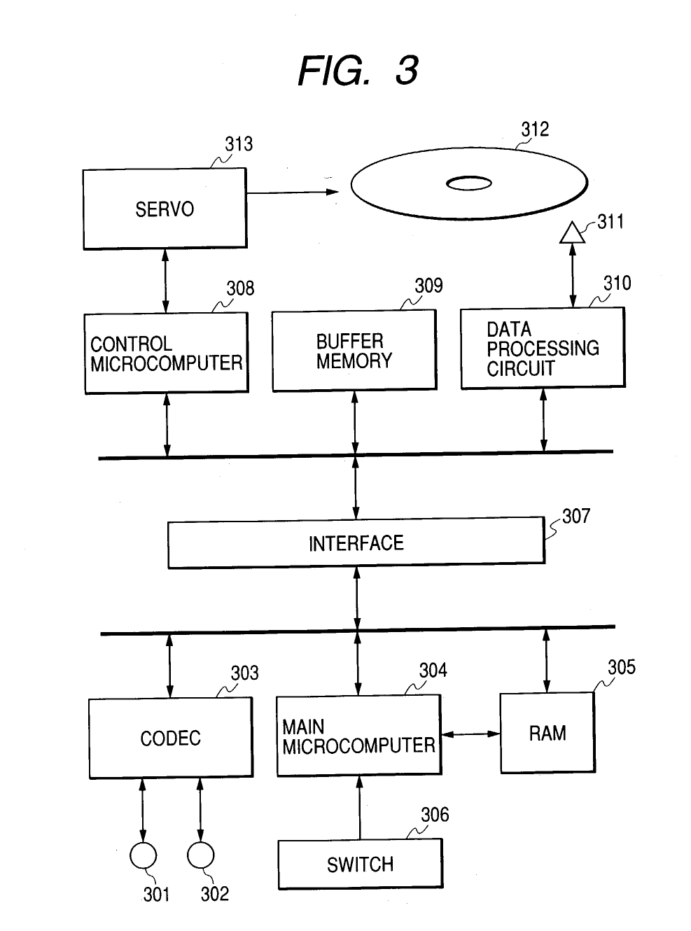

FIG. 3 is a block diagram of a recording/reproducing apparatus of this embodiment.

First, recording of data 1 (104 in FIG. 1) will be explained.

The data 1 is the first data to be recorded on this optical disk. Before this recording, this optical disk is assumed to have no data.

When a new optical disk having no data is inserted into the recording/reproducing apparatus, the apparatus recognizes the insertion of the optical disk. A control microcomputer 308 notices the insertion to a main microcomputer 304 via an interface 307. Then, the main microcomputer 304 recognizes that the inserted disk is an unused optical disk.

Because the unused optical disk has no anchor descriptor and management information, the main microcomputer 304 generates empty management information, which is not recorded onto an optical disk 312.

Next, when instructed by a switch 306 to record the data 1, the main microcomputer 304 judges a data amount of the data 1, and instructs, via the interface 307, the control microcomputer 308 to start recording of the data 1 from a sector of a predetermined number (a position of 106 in FIG. 1).

The main microcomputer 304 needs to previously judge an amount of data to be recorded. In recording image/sound data, an amount of the data can be calculated according to an average bit rate and recording time of the data. For example, when image/sound data of the data 1, which is a program of thirty minutes and encoded at an average bit rate of 6 Mbps, is recorded, the data amount is 1,350 M bytes (6 Mbps×1,800 seconds=10.8 G bits). When one sector has an amount of 2 KB, 67,500 sectors may be required. The outside of an unrecorded area, which outside contains 675,000 sectors, is used as the recording area. In other words, recording of the data 1 starts from a sector separated by 675,000 sectors inward from the outermost sector of the unrecorded area.

An average bit rate used for the recording is determined by the main microcomputer 304, and set in a CODEC circuit 303. On the other hand, a recording time of a TV program is previously determined. The main microcomputer 304 may also control the control microcomputer 308 and a data processing circuit 310 so that the recording time becomes equal to a predetermined time, according to the user's instruction. In recording a PC data file, whose amount is previously determined, the outside of the unrecorded area may be allocated to a recording area corresponding to the file amount.

Next, to record data from a sector (a position of 106 in FIG. 1) specified by the main microcomputer 304, the control microcomputer 308 instructs a servo 313 to control, e.g., the rotational frequency of the optical disk 312 and a position of the optical head 311.

The control microcomputer 308 causes the CODEC circuit 303 to compress the data 1. Image/sound data which is input from a sound input/output terminal 301 and image input/output terminal 302 is input to the CODEC circuit 303, and A/D converted to digital data. The digitalized image/sound data is compressed by the CODEC circuit 303. The image/sound data processed by the CODEC circuit 303 is stored in a buffer memory 309 via the interface 307.

The control microcomputer 308 confirms an amount of the image/sound data stored in the buffer memory 309. When the amount reaches a predetermined value, the control microcomputer 308 inputs the image/sound data from the buffer memory 309 to a data processing circuit 310, and causes the data processing circuit 310 to record the data. In the data processing circuit 310, the input data is encoded, for example added an error correcting code, and then modulated to be recorded onto an optical disk. The modulated data is recorded onto the optical disk 312 via the optical head 311.

When the recording of the data 1 is completed, management information 103a including a recorded area, identifier (file name), and property of the data 1 is recorded from the inside of the management information area. Also a number of the last sector of the recorded area is recorded as the management information. This number is used for judging a position for the next additional recording.

An anchor descriptor 102a showing a sector number of the management information 103a is recorded onto the anchor descriptor area.

Next, recording of data 2 will be explained in the following.

When the optical disk having only the data 1 is inserted into, or power is applied to the recording/reproducing apparatus, the main microcomputer 304 is notified of the insertion of the optical disk.

The main microcomputer 304 reads out the anchor descriptor 102a recorded on the optical disk 312. The main microcomputer 304 judges from the anchor descriptor 102a a recorded position of management information on the optical disk, reads out the management information 103a, and stores the management information 103a in a RAM 305. The anchor descriptor last recorded onto the anchor descriptor area is used as a valid anchor descriptor in order to accept the additional recording. The anchor descriptor may include a version number in order to judge whether the anchor descriptor is the latest.

When there is an instruction from the switch 306 to record the data 2, the main microcomputer 304 requires a number of a sector where the recording is started, according to the management information stored in the RAM 305. This is because the data 2 needs to be recorded onto an area where the data 1 is not recorded. As described above, the data 1 has been recorded on the area for 104. The last recorded portion is thus the last sector of the data 104. This last sector number can be obtained from the management information 103a. The main microcomputer 304 judges that the recording area for 104 is already fully used.

Next, the main microcomputer 304 judges an amount of the data 2, and instructs, via the interface 307, the control microcomputer 308 to start recording the data 2 from a position (107 in FIG. 1) separated by an amount of the data 2 inward from the outermost periphery of an unrecorded area of the optical disk 312.

The control microcomputer 308 instructs the servo 313 to control, e.g., the rotational frequency of the optical disk 312 and a position of the optical head 311 in order to start the data recording from a sector specified by the main microcomputer 304.

Then, the control microcomputer causes the data processing circuit 310 to record the data 2 onto the optical disk 312.

After the recording of the data 2 is completed, the management information 103b and the anchor descriptor 102b are recorded onto the management information area and the anchor descriptor area, respectively.

In this embodiment, because the management information 103 is recorded from the inside of the optical disk 312, and the data 104 is recorded from the outside, there is no possibility that either the management information area or data area comes short or is partially unused. Thus, the recording areas on the disk are efficiently used.

The present invention is not limited to the above-described embodiment where the management information is recorded just after a file is recorded. When the management information is often updated, the update may be executed on the main microcomputer 304, and the management information and anchor descriptor may be recorded only when the disk is ejected. This permits the frequency of additional recording of the anchor descriptors to decrease, and permits the areas on the disk to be more effectively used. In the above-described embodiment, the management information is recorded from the inside of the optical disk, and the data is recorded from the outside of the disk. The management information may be recorded from the outside of the optical disk, and the data may be recorded from the inside of the disk, obtaining the same effect as in the above-described embodiment. The recording medium is not limited to a non-rewritable optical disk. Any recording medium where data and management information can be recorded may be used. Data to be used is not limited to image/sound data. Program data for PCs also can be recorded.

Next, reproduction by the recording/reproducing apparatus of this embodiment will be explained in the following with reference to FIGS. 1, 3. The data 1, 2 has been already recorded on the optical disk.

First, when the optical disk is inserted into, or power is applied to the recording/reproducing apparatus, information about the insertion of the disk is sent from the control microcomputer 308 to the main microcomputer 304. The main microcomputer 304 instructs the control microcomputer to read out information about a sector where an anchor descriptor is recorded. The control microcomputer 308 reads out the specified sector information, and sends the information to the main microcomputer 304. As shown in FIG. 1, anchor descriptors 102a, 102b are recorded. Because anchor descriptors are additionally recorded, the last written anchor descriptor is judged to be a valid anchor descriptor. In FIG. 1, the anchor descriptor 102b is judged to be a valid anchor descriptor.

The main microcomputer 304 judges a recorded position of the management information from the anchor descriptor 102b which has been read out. The anchor descriptor 102b shows that the recorded position is 103b. Thus, the main microcomputer 304 reads out and analyzes the management information 103b.

The management information 103b includes identifiers, properties, and recorded areas of the data 1, 2.

The main microcomputer 304 notices to a user that the data 1, 2 is recorded, and prompts the user to select a file to be used. The file includes a PC data file and image/sound data such as a TV program and movie.

When a file is selected, the main microcomputer 304 judges a sector number of the selected file, and reproduces the data. The reproduced data is input into the CODEC circuit 303. In the CODEC circuit 303, after digitalized to expand, the data is D/A converted to analog image/sound data. The analog image/sound data is output to the image input/output terminal 302 and sound input/output terminal 301, respectively. When the reproduced data is PC program data, it is sent to a PC to be then processed.

As a result, the data can be reproduced from the optical disk where the file is recorded.

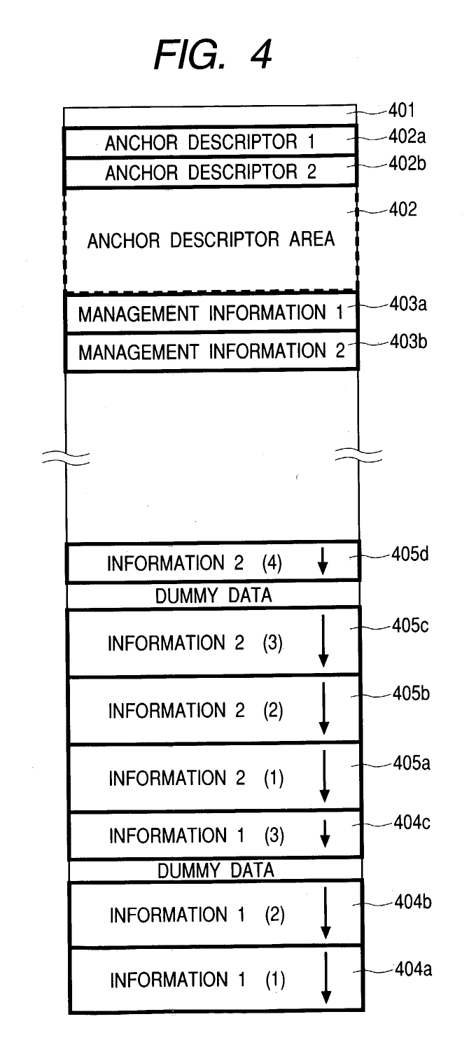

A recording/reproducing apparatus of a second embodiment will be explained in the following with reference to FIGS. 3, 4. In this embodiment, a recording medium is a non-rewritable optical disk where data is recorded additionally.

FIG. 4 shows file arrangement on the optical disk of this embodiment.

A recording area 401 has sectors each having a predetermined data amount. The configuration of sectors, anchor descriptors, and management information is the same as that in the first embodiment.

First, data 1 (404 in FIG. 4) will be explained.

The first process of the recording/reproducing apparatus when a new optical disk having no data is inserted into the apparatus is the same as that in the first embodiment.

When the switch 306 instructs the main microcomputer 304 to record the data 1, the main microcomputer 304 causes the CODEC circuit 303 to compress the data 1. Image/sound data which is input from the sound input/output terminal 301 and image input/output terminal 302 is input into the CODEC circuit 303, and A/D converted to digital data. The digitalized image/sound data is compressed by the CODEC circuit 303. The compressed image/sound data is stored into the buffer memory 309 via the interface 307.

The microcomputer 308 confirms an amount of the image/sound data stored in the buffer memory 309. When the amount reaches a predetermined value, the microcomputer 308 inputs the image/sound data from the buffer memory 309 to the data processing circuit 310, and causes the data processing circuit 310 to record the data. In the data processing circuit 310, the input information is encoded, for example added an error correcting code, and then modulated to be recorded onto the optical disk. The modulated data is recorded onto the optical disk 312 via the optical head 311.

Recording of the data 1 onto the optical disk will be explained in detail in the following.

In this embodiment, as shown in FIG. 4, the control microcomputer 308 divides the data 1 into blocks (404a to 404c) each having a plurality of sectors, and records the blocks onto a data recording area of the optical disk 312. In this case, the control microcomputer records the blocks (a data amount of one block is equal to an integral multiple of an ECC block) sequentially from the outside (a sector of a larger sector number) to inside (a sector of a smaller sector number). In each block area, the recording is executed from the inside (a sector of a smaller sector number) to outside (a sector of a larger sector number).

As a result, in this embodiment, because each block has successive sector numbers, no seek operation (movement of the optical head) is executed in recording data in each block, not causing the data recording rate to fall.

On the other hand, when the optical head moves from one block to another, a head position of the next block needs to be detected by the seek operation, causing the data recording rate to fall.

When the data amount in each block is set small, the seek operation is often executed between the blocks to thereby fall the data recording rate. On the other hand, when the data amount in each block is set large, an empty area on the last recorded block becomes large to thereby often waste the recording area. Thus, the data amount of each block needs to be determined in consideration of these facts. In this embodiment, one block has 8 MB (4,096 sectors). This amount can be arbitrarily changed. An optimum data amount is determined according to, e.g., the data recording rate.

In this embodiment, an amount of the data 1 is 20 MB.

After the data is recorded onto the whole of an area 404a, the optical head seeks the innermost periphery (sector of the smallest sector number) of an area 404b. Then, the data 1 is recorded from the inside (a sector of a smaller sector number) to outside (a sector of a larger sector number).

Likewise, when the area 404b is fully recorded, an area 404c is used. Because the amount of the data 1 is 20 MB, the recording is completed on the way of the area 404c, generating an empty area on the aft portion of the area 404c. The empty area is fully buried with dummy data.

When the recording of the data 1 is completed, the management information 403a including a recorded area, identifier (file name), and property of the data 1 is recorded onto the management information area. Also a number of a sector where the information is last recorded is recorded as the management information. The number is used for judging a position for the next additional recording.

Finally, the anchor descriptor 402a showing a sector number of the management information 403a is recorded onto the anchor descriptor area.

Next, recording of the data 2 will be explained in the following.

When an optical disk having only the data 1 is inserted into, or power is applied to the recording/reproducing apparatus, the main microcomputer 304 is notified of the insertion of the optical disk.

The main microcomputer 304 reads out an anchor descriptor 402a recorded on the optical disk 312. The main microcomputer 304 judges from the anchor descriptor 402a a recorded position of the management information on the optical disk, reads out the management information 403a, and stores the management information 403a into the RAM 305. The anchor descriptor last recorded onto the anchor descriptor recording area is used as a valid one for additional recording. The anchor descriptor may have a version number in order to judge whether the anchor descriptor is the latest.

When the main microcomputer 304 receives from the switch 306 an instruction to record the data 2, it requires, according to the management information stored in the RAM 305, a number of a sector where the recording is started, the sector being on the optical disk 312. This is because the data 2 needs to be recorded onto the recording area where the data 1 is not recorded. As described above, the data 1 is recorded in the order: 404a, 404b, 404c. The last recorded portion is the last sector of the data 404c. A number of the last sector is obtained from the management information 403a. The main microcomputer 304 judges that the recording areas up to 404c have been already used.

The main microcomputer 304 instructs, via the interface 307, the control microcomputer 308 to start data recording from a sector of a predetermined number.

The control microcomputer 308 instructs the servo 313 to control, e.g., the rotational frequency of the optical disk 312 and a position of the optical head 311 in order to execute data recording from a sector specified by the main microcomputer 304.

When the data 2 is input, the recording starts from an area 405a. When the area 405a is fully used, the data is recorded onto the areas in the order: 405b, 405c. The recording of the data 2 is completed on an area 405d. There is an empty area on the aft portion of 405d. The empty area is buried with dummy data because it is not used.

Management information 403b including a recorded area of the data 2 is recorded onto the management information area. The management information 403b which is new contains management information about the data 1, 2.

To exhibit a recorded position of the management information 403b, an anchor descriptor 402b is recorded after the anchor descriptor 402a.

Effects of this embodiment are as follows. The management information is recorded from the inside of the disk, and the data is recorded from the outside of the disk, so that there is no possibility that either the management information area or data area comes short or is partially unused. As a result, the recording area on the disk can be effectively used. Additionally, proper data recording can be executed without calculating an amount of the data.

The present invention is not limited to the above-described embodiment where the management information is recorded just after the data recording. When the management information is often updated, the update may be executed on the main microcomputer 304, and the management information and anchor descriptor may be recorded only when the disk is ejected.

As a result, the frequency of additional recording of the management information and anchor descriptors can be decreased so that the area on the disk can be used more efficiently.

Next, reproduction by the recording/reproducing apparatus of this embodiment will be explained with reference to FIGS. 3, 4.

The data 1, 2 has been already recorded on the optical disk.

When the optical disk is inserted into, or power is applied to the recording/reproducing apparatus, the main microcomputer 304 is notified of the insertion of the disk from the control microcomputer 308. The main microcomputer 304 instructs the control microcomputer 308 to read out sector information recorded on an anchor descriptor. The control microcomputer 308 reads out information of the specified sector, and sends the information to the main microcomputer 304. Like in the first embodiment, the anchor descriptor 402b is judged to be valid.

The main microcomputer 304 judges a recorded position of the management information from the anchor descriptor 402b which has been read out. The anchor descriptor 402b shows that a recorded position of the management information is 403b. The main microcomputer 304 reads out and analyzes the management information 403b.

The management information 403b includes identifiers, properties, and recorded areas of the data 1, 2.

The data 1 recorded on the optical disk 312 is reproduced by the optical head 311. In the data processing circuit 310, the data 1 is demodulated, and decoded, for example added an error correcting code. The decoded data is once stored in the buffer memory 309. In this embodiment, after 404a is reproduced, it takes a predetermined time for the optical head 311 to seek the inside (position of a smaller sector number) of 404b. However, by using the buffer memory 309, a seek time of the optical head 311 can be absorbed to thereby reproduce the data successively. Like in the first embodiment, the data which is output from the buffer memory via the interface 307 to the main microcomputer 304 is input to the CODEC circuit 303, digitalized, D/A converted, and output to the sound input/output terminal 301 and image input/output terminal 302.

As a result, the data can be reproduced from the optical disk.

In the second embodiment, the recording blocks are recorded from the outside. However, a sector number of the outside is not always higher, e.g., on a disk having upper and lower recording layers. The sector number may increase from the inside to outside on the first layer, and may increase from the outside to inside on the second layer. Also in this case, the same effects can be obtained using the present invention, when sectors in each block are recorded sequentially in the descending order of their sector numbers.

This embodiment is applicable to not only a non-rewritable optical disk but also any recording medium where data and management information can be recorded. This embodiment is also applicable to not only image/sound data but also program data for PCs.

According to the present invention, a recording method for efficiently using a recording area on a recording medium can be provided.

The foregoing invention has been described in terms of preferred embodiments. However, those skilled, in the art will recognize that many variations of such embodiments exist. Such variations are intended to be within the scope of the present invention and the appended claims.

What is claimed is:

1. A recording method for recording data and management information which manages the data onto a recording medium, comprising the steps of:
recording the data outward from a position separated by an amount of the data inward from the outermost periphery of a data recording area on the recording medium, the data recording area having an undetermined data amount; and
recording the management information outward from the innermost periphery of a management information recording area on the recording medium, the management information recording area having an undetermined data amount.

2. The recording method as set forth in claim 1, wherein,
when other data is already recorded on a data recording area on the recording medium, the data recording area having an undetermined data amount, the data is recorded outward from a position separated by an amount of the data inward from the outermost periphery of an unrecorded area of the data recording area, and
position information about a recorded position of the management information is recorded outward from the innermost periphery of an unrecorded area of position information recording area on the recording medium, the position information recording area having a determined data amount.

3. The recording method as set forth in claim 1, wherein
an amount of the data is detected, and
the data is recorded outward from a position separated by the detected data amount inward from the outermost periphery of a data recording area on the recording medium, the data recording area having an undetermined data amount.

4. The recording method as set forth in claim 3, wherein,
when other data is already recorded on a data recording area on the recording medium, the data recording area having an undetermined data amount, the data is recorded outward from a position separated by the detected data amount inward from the outermost periphery of an unrecorded area of the data recording area on the recording medium, and
position information about a recorded position of the management information is recorded outward from the innermost periphery of an unrecorded area of position information recording area on the recording medium, the position information recording area having a determined data amount.

5. A recording method for recording data and management information which manages the data onto a recording medium, comprising:
recording each predetermined recording unit of the data onto the range from the outermost periphery of a data recording area on the recording medium to a position separated by the recording unit inward from the outermost periphery, the data recording area having an undetermined data amount; and
recording the management information outward from the innermost periphery of a data recording area on the recording medium, the information recording area having an undetermined data amount.

6. The recording method as set forth in claim 5, wherein each predetermined recording unit of the data is recorded from the inside to outside.

7. The recording method as set forth in claim 5, wherein,
when other data is already recorded on a data recording area on the recording medium, the data recording area having an undetermined data amount, the each predetermined unit of the data is recorded onto the range from the outermost periphery of an unrecorded area of the data recording area to a position separated by an amount of the recording unit inward from the outermost periphery, and
position information showing a recorded position of the management information is recorded outward from the innermost periphery of an unrecorded area of a position information recording area, the position information recording area having a determined data amount.

8. The recording method as set forth in claim 7, wherein each recording unit of the data is recorded from the inside to outside.

9. A reproducing apparatus for reproducing data from a recording medium where predetermined recording units of the data are recorded from a position inner from other data already recorded on an data recording area having an undetermined data amount, and where management information which manages the data is recorded from a position outer from other management information already recorded on a management information recording area having an undetermined data amount, the apparatus comprising:
means for controlling reproduction of the recording units from the inside to outside, and reproduction of the data within the recording unit from the inside to outside.

10. A recording medium for recording data and management information which manages the data, wherein
the recording medium has on its own outside a data recording area having an undetermined data amount, and has on its own inside a management information area having an undetermined data amount, wherein
the data is recorded from the outermost periphery of the data recording area, and wherein
the management information is recorded outward from the innermost periphery of the management information area.

11. The recording medium as set forth in claim 10, wherein
the recording medium has on its own innermost periphery a position information recording area whose data amount is determined, wherein
the data is recorded outward from a position separated inward by the data amount from the outermost periphery of the data recording area, and wherein
position information about a recorded position of the management information is recorded outward from the innermost periphery of the position information recording area.
